(19) United States
(12) Patent Application Publication
(10) Pub. No.: US 2025/0176620 A1
(43) Pub. Date: Jun. 5, 2025

(54) COOKIE HOUSE PIPE WITH COOKIE MOUTHPIECE

(71) Applicant: Casey Andrew Bagenstos, Las Vegas, NV (US)

(72) Inventor: Casey Andrew Bagenstos, Las Vegas, NV (US)

(21) Appl. No.: 18/526,309

(22) Filed: Dec. 1, 2023

(51) Int. Cl. A24F 1/32; A21D 13/47; A21D 13/48; A24F 3/00; A24F 5/00; A24F 7/00

(52) U.S. Cl. CPC A24F 1/32; A21D 13/47; A21D 13/48; A24F 3/00; A24F 5/00; A24F 7/00

(57) ABSTRACT

A Cookie House pipe features a cookie chimney mouthpiece, and a down stem tube that extends through a wall of the cookie house, not through the roof. The pipe includes a cookie house with four walls, a floor, a roof with a chimney hole, and a chimney mounted to the roof over the chimney hole. The cookie pipe also includes a down stem tube extending through a wall, and a pipe bowl attachable to the glass downstem tube, the pipe bowl holding smokable material. The pipe bowl is in airflow communication with the chimney mouthpiece via the glass downstem tube and the chimney hole, such that when a user sucks on the chimney mouthpiece, smoke flows from the pipe bowl, through the glass downstem into the cookie house, and then up the chimney due to suction on the chimney. The cookie house pipe can be used for smoking tobacco, hemp, or herbal preparations.

### FIELD OF THE INVENTION

This invention relates generally to pipes for enjoyment of smoking, and more particularly to such pipes having edible components.

### BACKGROUND OF THE INVENTION

Gingerbread cookie house pipes are known. They are used to smoke a variety of materials, including hemp, tobacco, and herbal mixtures.

Typically, such pipes use a glass mouthpiece that extends upward from the roof of the gingerbread cookie house. However, many of these gingerbread cookie house pipes do not work well or reliably.

### SUMMARY OF THE INVENTION

The cookie house pipe of the invention features a cookie mouthpiece, and a glass downstem tube that extends through the front wall of the cookie house, not through the roof.

The cookie house pipe of the invention can be used for smoking tobacco, hemp, or other herbal preparations. The pipe can also be used as an incense burner.

A general aspect of the invention is a cookie house pipe for smoking smokable material. The cookie house pipe includes: a cookie house having four walls, a floor, a roof with a chimney hole, and a chimney mounted to the roof over the chimney hole, the chimney configured to be used as a mouthpiece. The cookie house pipe also includes a glass downstem tube extending through the front wall of the cookie house, the glass downstem tube having a wide end and a narrow end, the narrow end slanting downward within the cookie house, the wide end slanting upward outside the cookie house; and a pipe bowl attachable to the wide end of the glass downstem tube, the pipe bowl configured to hold material to be smoked.

The pipe bowl is thereby in airflow communication with the chimney via the down stem tube and the chimney hole, such that when a user sucks on the chimney, smoke flows from the pipe bowl, through the glass downstem into the cookie house, and then up the chimney due to suction on the chimney.

In some embodiments, the chimney hole in the roof is square.

In some embodiments, the chimney is mounted in an airtight sealed relationship to the roof over the chimney hole using icing.

In some embodiments, the cookie house further includes: a floor in airtight sealed relationship with the four walls of the cookie house.

In some embodiments, the floor and roof are sealed in an airtight sealed relationship with the four walls of the cookie house using icing.

In some embodiments, two of the walls are peaked, and two of the walls are rectangular or square.

In some embodiments, the glass downstem tube extends through a peaked wall of the cookie house.

In some embodiments, the peaked wall the glass downstem tube extends through is the front wall of the cookie house.

In some embodiments, one of the two peaked walls includes a hole configured to allow the glass downstem tube to extend therethrough.

In some embodiments, the glass downstem tube that extends through the hole is airtight sealed to the hole using icing.

In some embodiments, the chimney is made from cookie.

In some embodiments, the walls, floor, and the roof are all made from cookie.

### BRIEF DESCRIPTION OF THE DRAWINGS

Many additional features and advantages will become apparent to those skilled in the art upon reading the following description, when considered in conjunction with the accompanying drawings, wherein:

FIG. 1 is a perspective view showing the cookie house pipe from the front with the cookie chimney mouthpiece fully assembled and glass bowl and downstem in place.

FIG. 2 is a side view of the Cookie House Pipe, showing a user drawing smoke from the cookie chimney.

FIG. 3 is a side view of the Cookie House Pipe showing a wall removed to reveal the inside of the cookie house and the glass downstem extending through the front wall of the house.

FIG. 4 is a top view of a glass downstem, showing the wide end for receiving a pipe bowl, and a narrow end for extending into the house.

FIG. 5 is a side view of a pipe bowl for insertion into the wide end of the downstem.

FIG. 6 shows a cookie heart pipe design and a cookie castle pipe design.

FIG. 7 shows a cookie snowman pipe design and a cookie pumpkin pipe design.

FIG. 8 is a top view showing the cookie house pipe with the cookie chimney mouthpiece fully assembled and glass bowl and downstem in place. Showing through the cookie chimney mouthpiece is the chimney hole in which the airway is formed to allow for operation of the cookie house pipe.

FIG. 9 is a perspective view showing the cookie house pipe from the back with the cookie chimney mouthpiece fully assembled.

FIG. 10 is a perspective view showing the smaller version of the cookie house pipe from the front with the cookie chimney mouthpiece fully assembled and glass bowl and downstem in place.

FIG. 11 is a black and white drawing perspective view showing the cookie house pipe from the front with the cookie chimney mouthpiece fully assembled and glass bowl and downstem in place.

FIG. 12 is a black and white drawing perspective view showing the cookie house pipe from the back with the cookie chimney mouthpiece fully assembled.

FIG. 13 is a black and white drawing top view showing the cookie house pipe with the cookie chimney mouthpiece fully assembled and glass bowl and downstem in place.

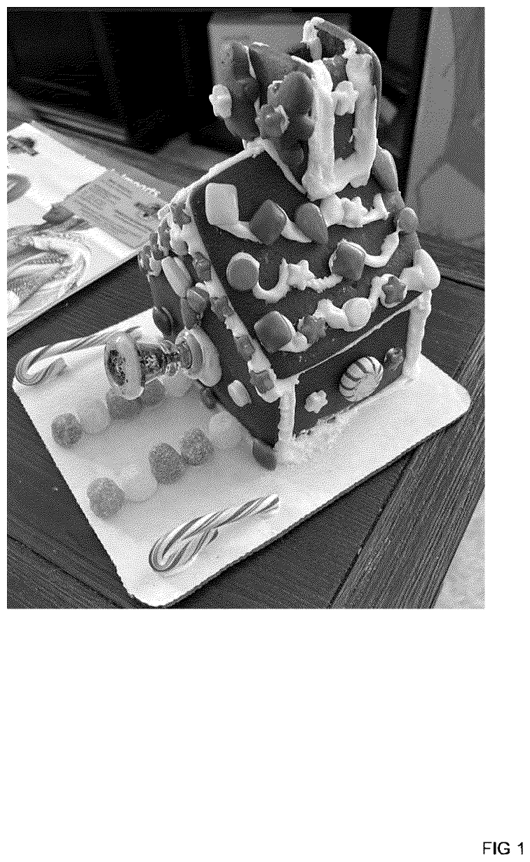

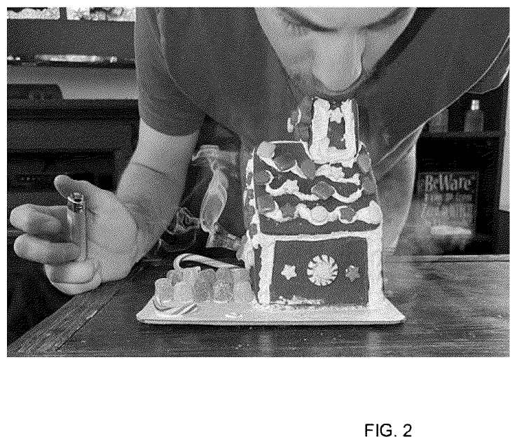

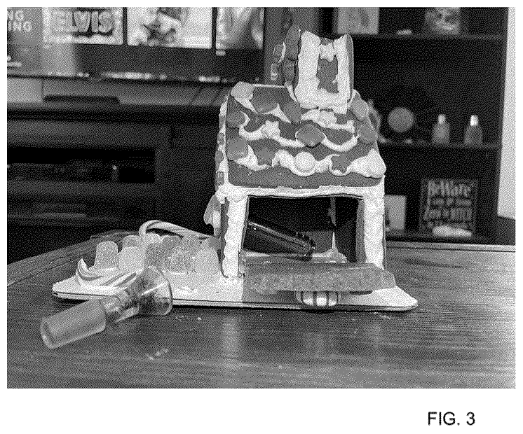

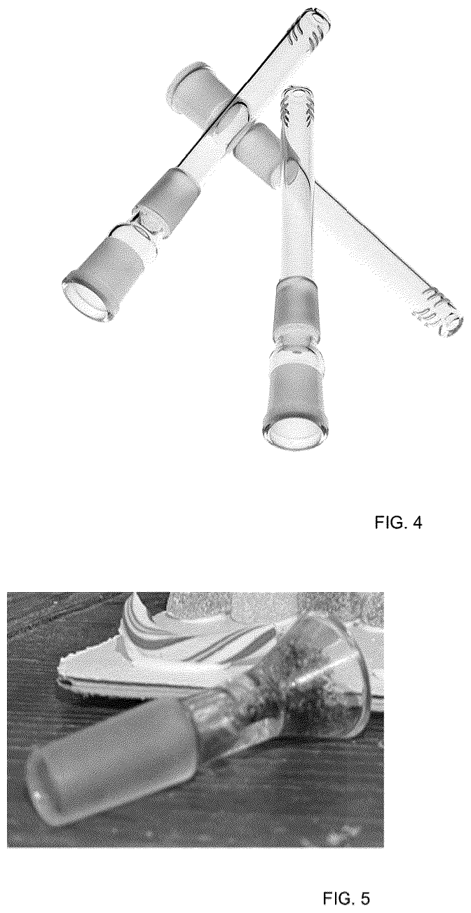

### DRAWINGS—REFERENCE NUMERALS

Floor—10
Right Side Wall—12
Left Side Wall—14
Back Wall—16
Front Wall—18
Left Side Roof—20
Right Side Roof—22
Right Side Chimney—24
Front Side Chimney—26
Left Side Chimney—28
Back Side Chimney—30
Chimney Hole—32
glass downstem—34
glass downstem Hole—36
Glass Pipe Bowl—38
Icing—40

### DETAILED DESCRIPTION—FIGS

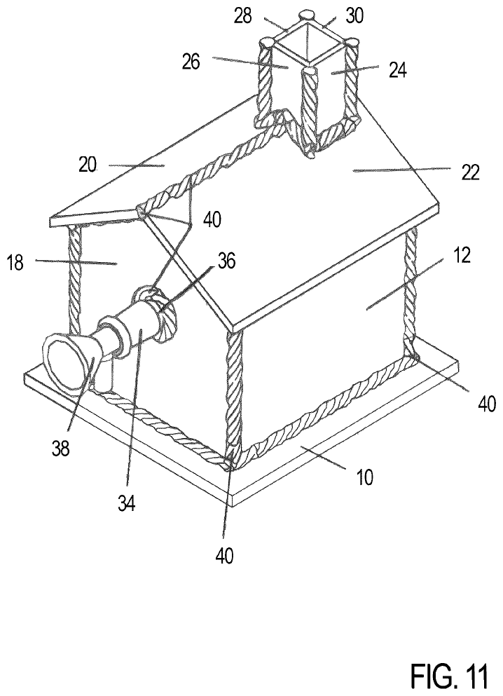

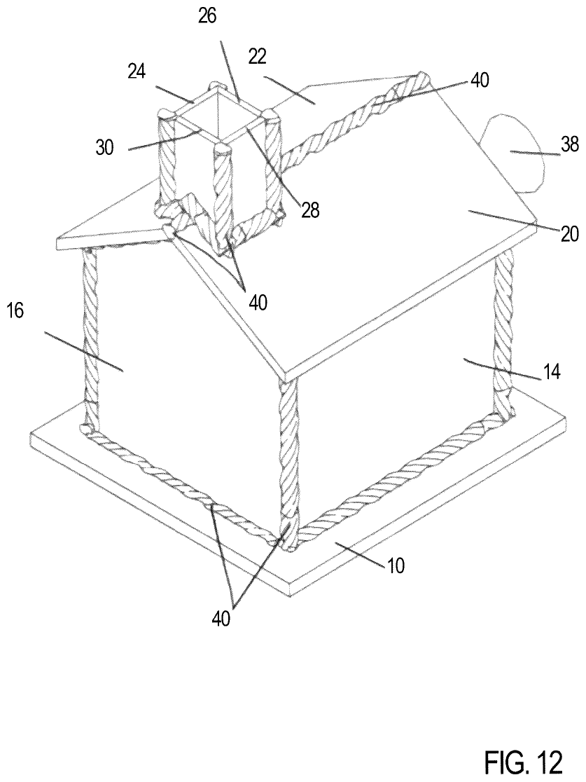

The embodiment of the product is represented in FIGS. 11, 12 and 13. The start of the house is with the floor 10 where Icing 40 is placed along the two longer sides and the left side wall 14 and the right side wall 12 are placed on top. The icing 40 is providing stability for the left side wall 14 and the right side wall 12 to stay in place. The front wall 18 and back wall 16 are placed on the shorter sides of the floor 10 and secured with icing 40. Then the front 18 and back wall 16 are secured to the left side wall 14 and right side wall 12 where the cookie touches, using icing 40. The left side roof 20 is assembled next with the icing 40 along the top of the left side wall 14, top of the back wall 16 and top of the front wall 18. The right side roof 22 will be added with the icing 40 along the top of the right side wall 12, the top of the back wall 16 and the top of the front wall 18. When placing both the right side roof 22 and left side roof 20, make sure to place the hole for the chimney mouthpiece 28 at the back of the cookie house, opposite side in which the glass downstem 34 is placed. Left side chimney 28 will have icing 40 on the bottom and be placed on the back left side roof 20 around the chimney hole 32. Right side chimney 24 will have icing 40 on the bottom and placed on the back right side roof 22 on the right side of the chimney hole 32. Chimney front side will have icing 40 along the bottom of it and placed in front of the chimney hole 32. Chimney back side 30 will have icing 40 along the bottom of it and placed around the back side of the chimney hole 32. After all chimney sides (24,26,28,30) are secured around the chimney hole 32 take the icing 40 and apply a layer to the sides of the chimney (24,26,28,30) to secure a tight seal. The left side chimney will be secured with icing 40 to the front side chimney 26 and back side chimney 30. Right side chimney 24 will be secured with icing 40 to front side chimney 26 and back side chimney 30. Take glass downstem 34 and place the narrow end in the glass downstem hole 36 which is located in the front wall 18. Once the glass downstem 34 is fully inserted in the glass downstem hole 36 secure the glass downstem 34 with icing 40 where the glass downstem 34 connects to the front wall 18. The icing 40 will create a tight seal. Add the glass pipe bowl 38 to the open end of the glass downstem 34. The cookie house pipe will be completely assembled.

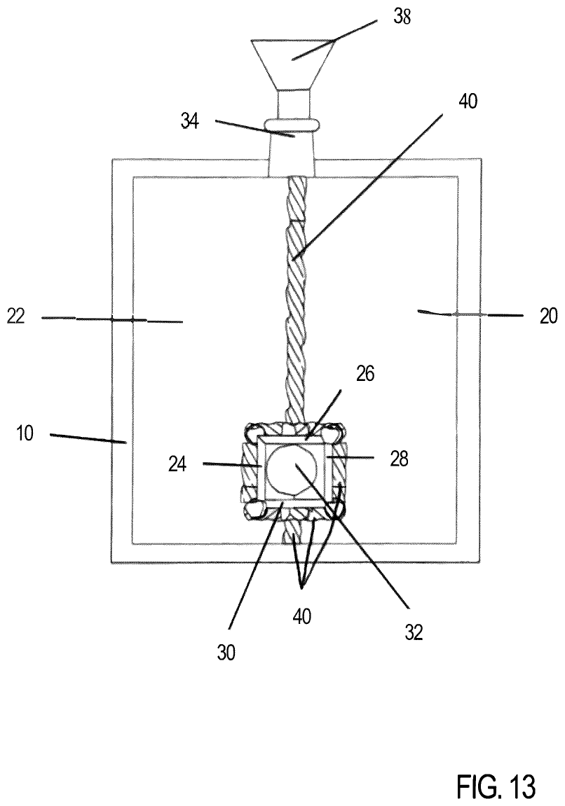

### Operation—FIG. 13

In known gingerbread cookie house pipes, there is no hole in the roof for the chimney, since the chimney is just for decoration. By contrast, in the cookie house pipe of the invention, there must be a chimney hole in the roof, so that the chimney can be mounted to the roof over the chimney hole, allowing the chimney to be used as a mouthpiece.

Putting the glass downstem through the wall instead of the roof solves a large safety problem. In many known gingerbread house pipes, the glass downstem extends through the roof, so the flame created when lighting the pipe bowl in the glass downstem can be too close to the user's face, and could thereby cause serious burns or possibly cause their hair to catch fire.

The other issue with the glass downstem extending through the roof is that the airflow from the glass downstem through the roof won't work as well as a glass downstem through a wall, due to the location of the bottom of the glass downstem within the structure.

With the glass downstem extending through the wall, the suction from the chimney can pull the smoke more easily through the glass downstem and up through the chimney.

We attach the glass downstem secured through the wall with an airtight seal by using the icing (also called frosting) as set forth below. After hardening, the seal made thereby is completely airtight.

### Icing Ingredients

Royal Icing•Royal Icing (used to assemble products): Powder Sugar (sugar, cornstarch). Water, Meringue Powder (sugar, dry egg whites, corn starch, leavening (ammonium aluminum sulfate), salt, cellulose gum, Arabic gum, artificial flavor). Cream of Tartar, Vanilla Powder (dextrose, corn starch, vanilla bean extractives, artificial flavor). Contains: eggs & wheat.
   This Icing Formula could Also be Used:
   Halloween Green Royal Icing: Powdered Sugar (sugar, cornstarch), Water, Meringue Powder (sugar, dry egg whites, corn starch, Green Food Coloring (Water, sugar, FD&C yellow 5, yellow 6, blue 1, modified corn starch, vegetable gum, citric acid, less 1/10 of 1%; sodium benzoate, potassium sorbate), Meringue Powder (sugar, dry egg whites, corn starch), leavening (ammonium aluminum sulfate), salt, cellulose gum, Arabic gum, artificial flavor), Cream of Tartar, Vanilla Powder (dextrose, corn starch, vanilla bean extractives, artificial flavor). Contains: eggs & wheat.

When the air is very dry, the icing can harden very quickly without any refrigeration. When assembling the cookie house pipe with higher humidity, for example, about 40-55% humidity and around 100 degrees, it's best to put the cookie house in a refrigerator multiple times during the assembly process. The icing hardens sufficiently after only about 20-40 minutes in the fridge. Then it can be removed from the refrigerator, and effectively be used outside the fridge.

The cookie house of the invention can be made using parts from standard gingerbread house kits, as is known to those skilled in the art, such as can be obtained from:

### Gingerbread Traditions, Inc.

### 16578 SW 72nd Avenue

### Portland, OR 97224

For example:
http://shop.gingerbreadtraditions.com/alpine-gingerbread-house-kit---unassembled_p309.aspx
For example, roof pieces can be used from this kit for the walls.
http://shop.gingerbreadtraditions.com/cabin-gingerbread-house-kit---unassembled_p264.aspx
For example, this is the chimney set that can be used for the mouthpiece.
http://shop.gingerbreadtraditions.com/chimney-set-0429.aspx

The holes for the glass downstem and for the chimney are not found in these kits, but can be made as shown and/or described herein.

The glass downstem and glass pipe bowl can be obtained from any online glass or smoke retailer.

For example:
https://ssmokeshop.com/product/2-glass-class
downstem-diffuser-low-profile-14mm18mm/
https://marijuanapackaging.com/products/honeycomb-knocker-handle-bowl-glass-14mm-male-assorted

The cookie house pipe invention can be made in a variety of sizes ranging from the smallest at 2.5″×2.5″×3″ to the largest at 6″×6″×7″.

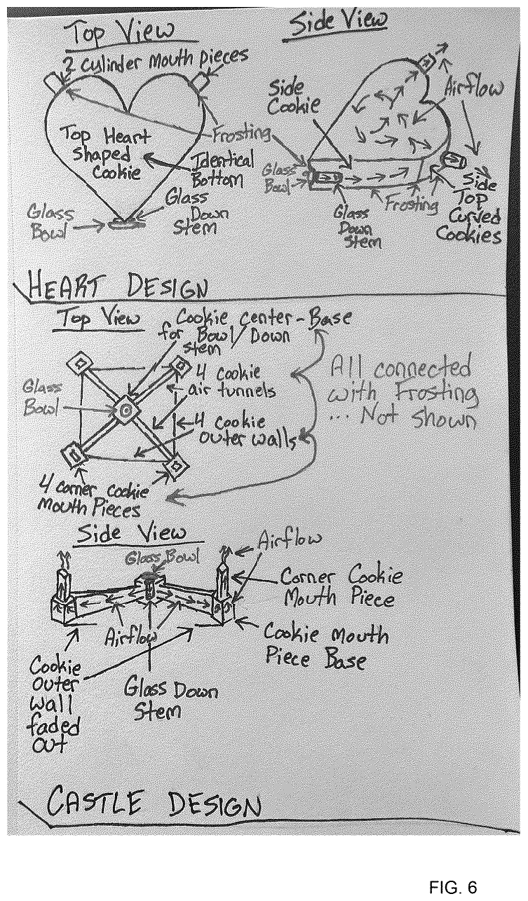

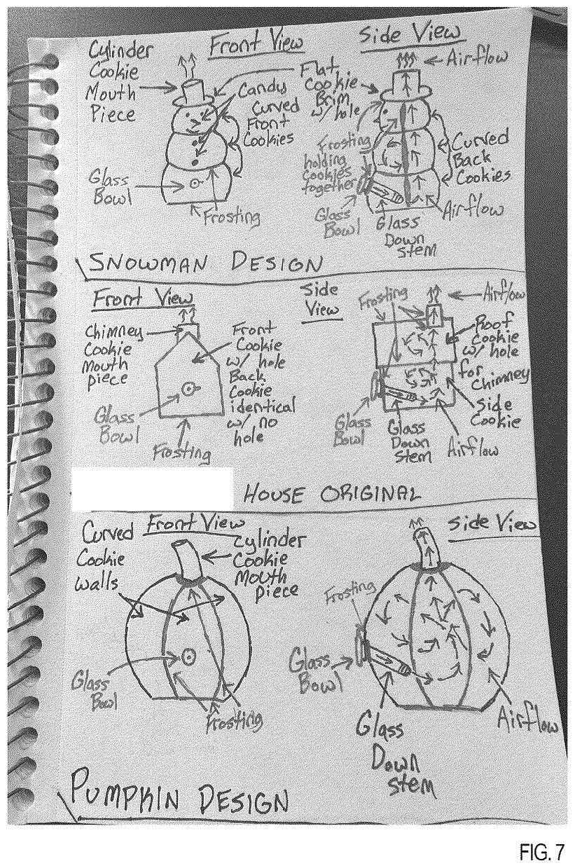

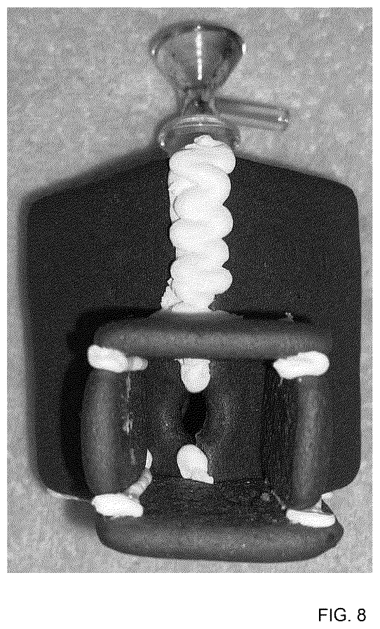

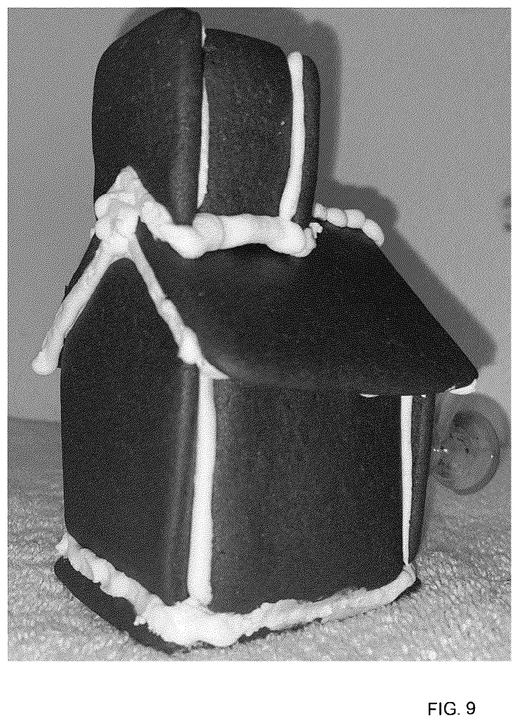

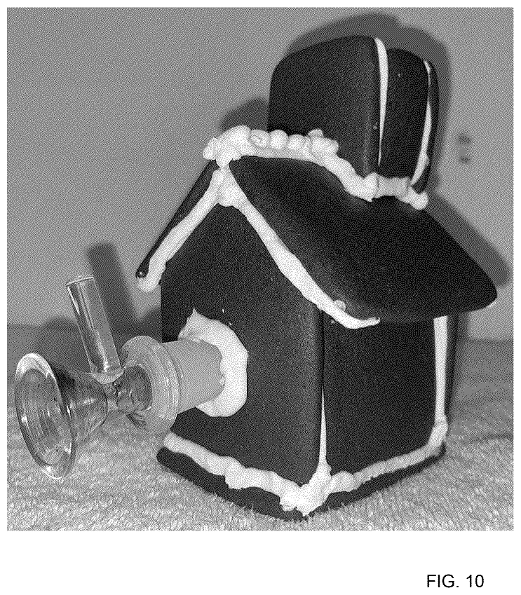

### Alternative Embodiments—FIG. 6 & FIG. 7

The same method for creating a pipe from a gingerbread house can be used for other objects and/or themes. For example, FIG. 6 & FIG. 7 show other items that are shown transformed into a pipe with an edible mouthpiece and a glass downstem inserted through a part of the object.

For example, the heart pipe can be made from sugar cookies, or peanut butter cookies, or pumpkin cookies, or gingerbread. Also shown are a snowman, a pumpkin, etc. The heart pipe will be made using sugar cookies and the pumpkin pipe will be made using pumpkin cookies.

The heart doesn't have a chimney, but has two mouthpieces nevertheless. Both mouthpieces are made of cookie and can be cylinder shaped. The two mouthpieces allow for two different users to be able to use the heart shaped cookie pipe at the same time. The snowman hat can be the mouthpiece just like the chimney, and the pumpkin stalk can be the mouthpiece of the pumpkin pipe.

What is claimed is:

1. A cookie house pipe for smoking smokable material, the cookie house pipe comprising:
a cookie house including:
four walls,
a floor,
a roof having a chimney hole, and
a chimney mounted to the roof over the chimney hole, the chimney configured to be used as a mouthpiece;
a glass downstem tube extending through a wall of the cookie house, the down stem tube having a wide end and a narrow end, the narrow end slanting downward within the Cookie House, the wide end slanting upward outside the cookie house; and
a pipe bowl attachable to the wide end of the glass downstem tube, the pipe bowl configured to hold material to be smoked,
the pipe bowl thereby being in airflow communication with the chimney via the glass downstem tube and the chimney hole, such that when a user sucks on the chimney, smoke flows from the pipe bowl, through the glass downstem into the cookie house, and then up the chimney due to suction on the chimney.

2. The cookie house pipe of claim 1, wherein the chimney hole in the roof is square or circle.

3. The cookie house pipe of claim 1, wherein the chimney is mounted in airtight sealed relationship to the roof over the chimney hole using icing.

4. The cookie house pipe of claim 1, wherein the cookie house further includes: a floor in airtight sealed relationship with the four walls of the cookie house.

5. The cookie house pipe of claim 1, wherein the floor is sealed in airtight sealed relationship with the four walls of the cookie house using icing.

6. The cookie house pipe of claim 1, wherein two of the walls are peaked, and two of the walls are rectangular or square.

7. The cookie house pipe of claim 6, wherein the glass downstem tube extends through a peaked wall of the cookie house.

8. The cookie house pipe of claim 6, wherein the glass downstem tube extends through a rectangular or square wall of the cookie House.

9. The cookie house pipe of claim 1, wherein one of the four walls includes a hole configured to allow the glass downstem tube to extend therethrough.

10. The cookie house pipe of claim 9, wherein the glass downstem tube that extends through the hole is airtight sealed to the hole using icing.

11. The cookie house pipe of claim 1, wherein the chimney is made from cookie.

12. The cookie house pipe of claim 1, wherein the walls, floor, and the roof are all made from cookie.
